(19) United States
(12) Patent Application Publication
(10) Pub. No.: US 2014/0172554 A1
(43) Pub. Date: Jun. 19, 2014

(54) METHOD AND APPARATUS FOR SELECTING A PREFERRED MESSAGE

(71) Applicant: WAL-MART STORES, INC., Bentonville, AR (US)

(72) Inventors: Stuart Argue, Palo Alto, CA (US); Anthony Emile Marcar, San Francisco, CA (US)

(73) Assignee: Wal-Mart Stores, Inc., Bentonville, AR (US)

(21) Appl. No.: 13/719,087

(22) Filed: Dec. 18, 2012

(51) Int. Cl. G06Q 30/02

(52) U.S. Cl. CPC G06Q 30/0251
USPC 705/14.49

(57) ABSTRACT

A computer-implemented method is described and includes, in a computerized server, receiving a candidate message from each of a plurality of designers. The candidate message is sent to a plurality of target recipients, and actions of the target recipients are monitored in response to the candidate message, including compiling metrics associated with the actions of the target recipients. The metrics for the candidate messages are compared, and one of the candidate messages is selected as a preferred message based upon the comparing.

### BACKGROUND INFORMATION

### Field of the Disclosure

The present disclosure relates generally to marketing methods and systems. In particular, examples of the present disclosure are related to methods and systems for determining preferred messages employed in marketing by an entity.

### Background

On-line/retail marketers have access to lists of clients with whom they can communicate via the Internet. Such communication can take the form of sending an email message to an email account, sending a webpage message to a personal communications device, e.g., a cell phone message to a telephone number, or employing another electronic communications system. According to one embodiment, a smart-phone or other electronic device can be configured to accept “push” messages from an advertiser, wherein a message providing an advertisement or marketing offer pops up on the screen of the device without being prompted by the user. A marketer wants to maximize efficacy of a marketing message in order to grow or sustain the business. Independent designers can develop marketing messages, but efficacy can be unknown unless tested or evaluated in some manner.

### BRIEF DESCRIPTION OF THE DRAWINGS

Non-limiting and non-exhaustive embodiments of the present disclosure are described with reference to the following figures, wherein like reference numerals refer to like parts throughout the various views unless otherwise specified.

FIG. 1 is a schematic illustrating a process by which a message can be communicated to a receiver network, according to some embodiments of the present disclosure;

FIG. 2 is a schematic illustrating a process for developing a proposed message, network according to some embodiments of the present disclosure; and

FIG. 3 is a schematic illustrating a process by which an entity develops and selects a preferred message for distribution to a plurality of potential clients, network according to some embodiments of the present disclosure.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present disclosure. It will be apparent, however, to one having ordinary skill in the art that the specific detail need not be employed to practice the present disclosure. In other instances, well-known materials or methods have not been described in detail in order to avoid obscuring the present disclosure.

Reference throughout this specification to “one embodiment”, “an embodiment”, “one example” or “an example” means that a particular feature, structure or characteristic described in connection with the embodiment or example is included in at least one embodiment of the present disclosure. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present disclosure may take the form of a computer program product embodied in any tangible medium of expression having computer-usable program code embodied in the medium.

A computer-implemented method is described and includes, in a computerized server, receiving a candidate message from each of a plurality of designers. The candidate message is sent to a plurality of target recipients, for example, customers with contact information contained on a customer contact list, and actions of the target recipients are monitored in response to the candidate message, including compiling metrics associated with the actions of the target recipients. Metrics can include monitoring a rate at which customers open an email, click on a button presented on an advertisement, how many customers complete a purchase after having utilized a candidate message, or other similar metrics. The metrics for the candidate messages are compared, and one of the candidate messages is selected as a preferred message based upon the comparing.

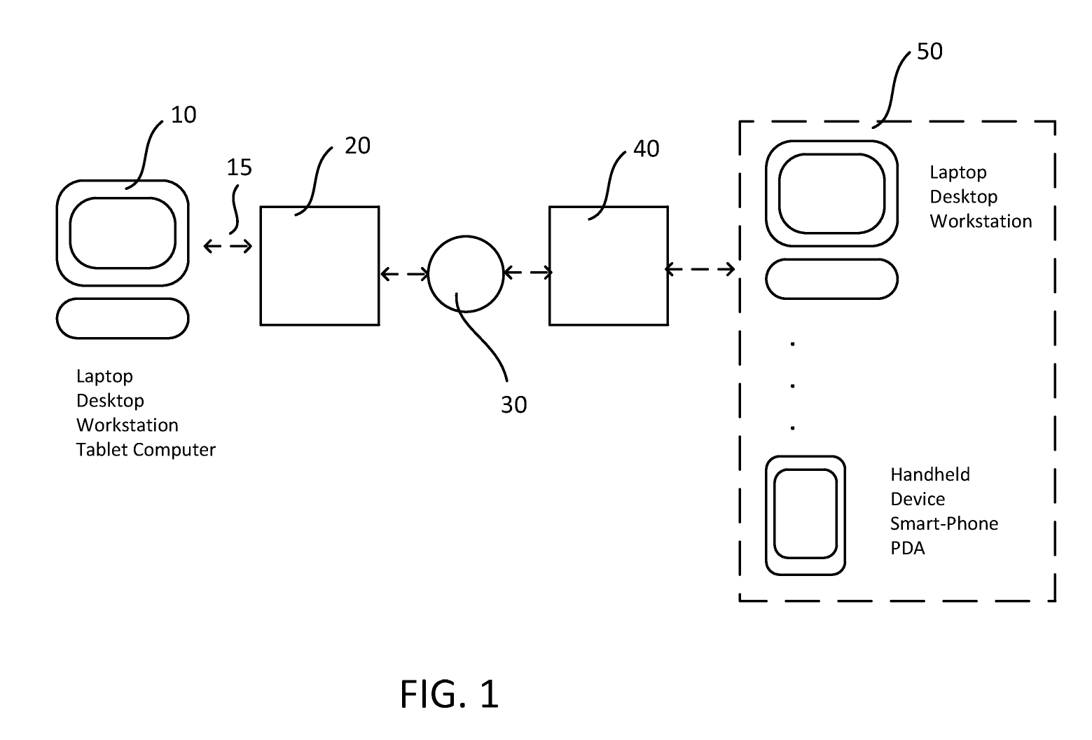

To illustrate, FIG. 1 schematically shows elements of a process by which a message can be communicated to a remote receiver in accordance with an embodiment of this disclosure. A sender employs a local electronic device 10 to generate a message 15 that is communicated to a receiver employing a remote device 50. The remote device 50 can be in the form of a handheld electronic device such as a personal communications device (PCD), e.g., a smart phone, a laptop computer, a desktop computer, an on-vehicle communications system or another device that signally connects to an external communications system using wireless or wired communications systems such as a high-speed Internet connection. The local work station 10 communicates message 15 to a local server 20. The local server 20 regularly and periodically communicates to a network 30 that communicates with a remote server 40, which in turn communicates the message 15 to the remote device 50. The local work station 10 and the remote device 50 have unique electronic addresses, e.g., email addresses and telephone numbers, which are employed to facilitate communications. In this or another suitable manner, message 15 can be electronically communicated from the sender to a receiver that is identified by their unique address. These elements are meant to be illustrative and not restrictive. Other process elements may be used to replace or supplement the illustrated elements. Remote device 50 can be a single device or representative of a number of devices utilized, for example, in a marketing department of a retail store chain.

Messages sent through router 40 can be automatically processed through modules within server 40, for example, with a compliance module screening out messages sent to the server that do not meet certain criteria. Exemplary criteria might include a requirement that a message include a hyperlink to a particular store webpage or that messages not include attached graphics files that exceed a certain size limit. Other modules in server 40 may sort the messages for routing to different workstations or departments within the marketing department. Router 40 can also include a module including programming to facilitate effective drafting of messages by the user of device 10. In one exemplary embodiment, device 10 can enable a user to login to a creative webpage operated by a module on server 40. In another example, a module on server 40 might enable downloading and updating of software to be run on device 10 to facilitate creation of new messages. A module within server 40 can store customer email addresses, phone numbers, or other information for sending messages to the customers. A module within server 40 can store messages, process results from messages being sent to customers and the responses of customers to those messages, and/or facilitate an operator on remote device 50 reviewing and manipulating messages or controlling which messages are sent to intended customer recipients. A module on server 40 can tabulate contest results between various contestants and provide or facilitate providing a reward to winners of the contest. Additionally, a module on server 40 could coach losing contestants, for example, providing examples of past winners, providing statistical or demographic results of the various contestants including the losing contestants message, and provide for feedback from the marketing department. A number of modules within server 40 for facilitating creation of messages and/or receiving and processing messages once received are envisioned, and the disclosure is not intended to be limited to the particular embodiments disclosed herein.

Messages selected for sending to potential customers can be sent to email addresses, cell phone numbers, or through other delivery methods known in the art through server 40 to network 30 and to the intended recipients through messages known in the art.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

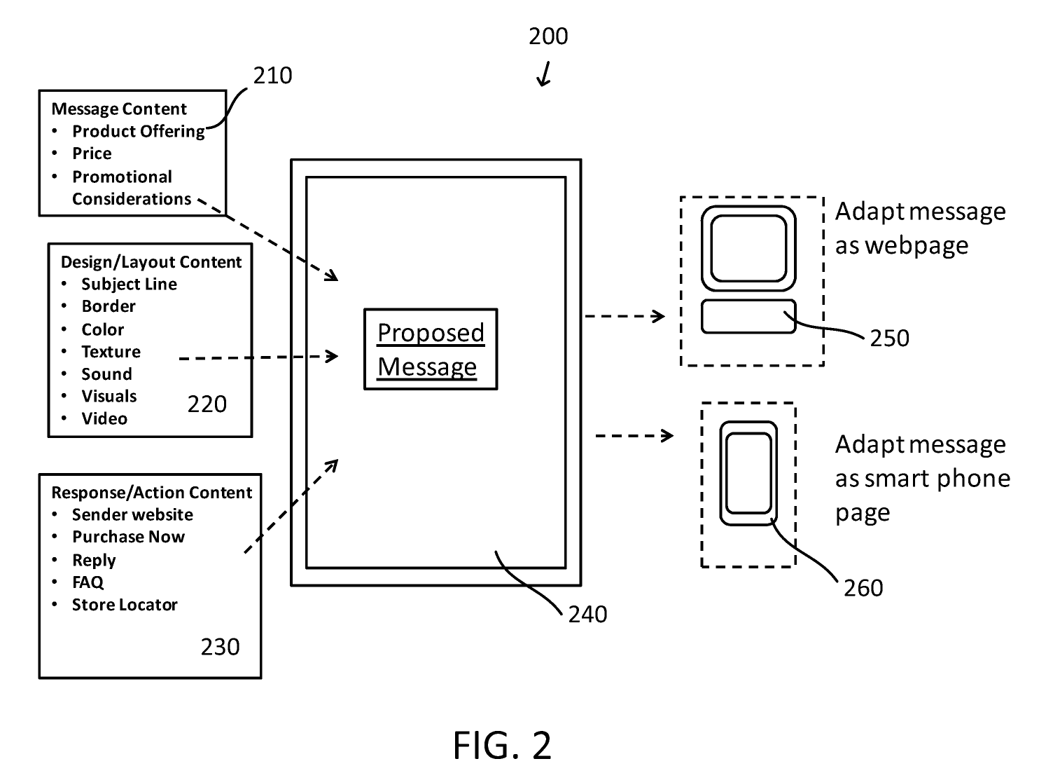

FIG. 2 schematically shows a process 200 for developing a proposed message 240. The proposed message 240 is preferably able to be formatted as a webpage for a workstation, as a screen page for a PCD, or as a page for another suitable device. Each proposed message 240 has message content 210, display content 220, and response/action content 230.

The message content 210 includes information that the sender wants to convey to the receiver. The message content 210 may include product offering(s), price, promotional considerations, offering date and time limitations, retail outlet locations, and other details. The sender specifies the message content 210.

The display content 220 includes selectable details related to presentation of the message content 210. The display content 220 may include information related to a message subject line, border content, color(s), texture, sound, visual(s), and video information, and other related details. A designer specifies or suggests the display content 220 and presentation of the message content 210 and the response/action content 230.

The response/action content 230 includes selectable details of desired or permissible responses or actions by the message receiver. The response/action content 230 may include a selectable hyperlink to the sender's website, a store locator, a “purchase now” hyperlink, a message reply seeking additional information from the sender, a frequently asked questions (FAQ) link, and/or other related responses or actions by the message receiver.

A designer generates a proposed message 240 by integrating the message content 210 and the response/action content 230 with selected display content 220. Format of the proposed message 240 is preferably adapted for receipt as an email message 250, e.g., as a webpage on a workstation. Format of the proposed message 240 is preferably also adapted for receipt as a smart phone page 260 that is viewable as a message on a PCD.

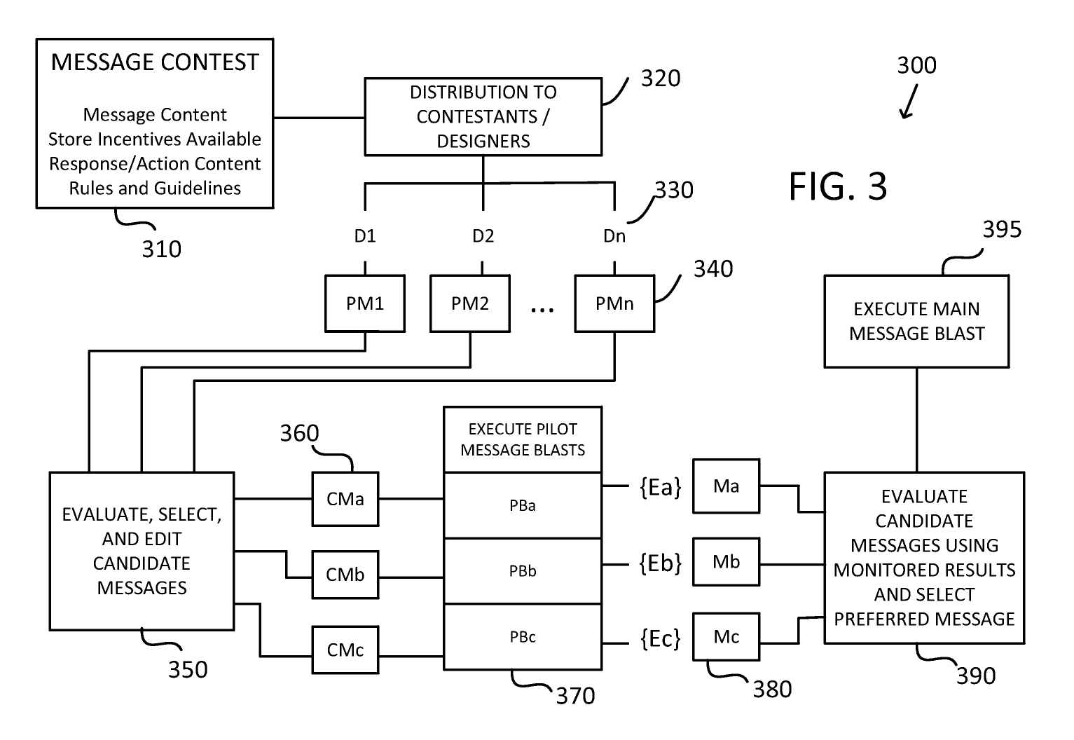

FIG. 3 illustrates a flowchart of an exemplary process by which an entity develops and selects a preferred message for distribution to a plurality of potential clients. The entity seeks to convey a message to a plurality of clients. By way of example, an entity may include a retailer of products and/or services that has a plurality of retail outlets and/or distribution centers located in different geographic locations. The entity has access to a list of current or potential clients, preferably including an electronic mail (e-mail) address or telephone number that connects to a PCD. The list of current or potential clients may further include additional information related to some or all of the clients, such as demographic information or purchase preferences.

In operation, an entity promulgates a message contest 310 having as its objective the development and submission of a message that effectively reaches the greatest quantity of the current and potential clients. A message is deemed to have effectively reached the greatest quantity of current and potential clients based upon objective metrics such as message open rates, viewing times, responses, and/or other suitable objective metrics that can be gleaned from monitoring. The message contest provides an opportunity for one or more message designers to submit proposed messages for consideration and evaluation. Content of the message contest 310 includes an objective of the contest, expected or required message content, e.g., the message content 210 described herein, message guidelines, and contest rules. The message guidelines relate to legal, organizational and other requirements and preferences of the entity, and can include information related to allowable and prohibited content such trademarks, images, colors, and the like. The contest rules relate to the structure of the contest, and preferably include contest submission processes and decision dates, evaluation metrics and decision criteria, contractual details including ownership rights in each message, contest awards, e.g., remunerations, and other suitable elements.

A distribution system 320 is employed to communicate the message contest 310 to a plurality of message designers (D1, D2, . . . Dn) 330. The distribution system 320 may include one or more of individualized contacts with a plurality of known or targeted message designers, a public announcement, e.g., via a broadcasted posting on the Internet, and/or other suitable mechanisms that can be employed to convey details of the message contest 310 to a plurality of designers.

Message designers 330 generate proposed messages (PM1, PM2, . . . PMn) 340, which are conveyed in a suitable format to the entity.

The entity employs predetermined criteria to evaluate, edit and select specific ones of the proposed messages 340 as candidate messages 350. As shown, three of the proposed messages 340 are selected as candidate messages (CMa, CMb, CMc) 360. It is appreciated that any suitable quantity of candidate messages 360 may be selected.

Pilot blasts (PBa, PBb, PBc) 370 are employed to send the candidate messages (CMa, CMb, CMc) 360 to subsets of target clients ({Ea}, {Eb}, {Ec}) with accompanying monitoring schemes (Ma, Mb, Mc) 380 that monitor the actions of the target clients in response to the received candidate messages (CMa, CMb, CMc) 360. Each of the pilot blasts (PBa, PBb, PBc) 370 includes sending one of the candidate messages (CMa, CMb, CMc) 360 to a subset of the current or potential clients.

Each of the subsets of the current or potential clients represents a small portion of the list of current or potential clients, and may be selected randomly or in accordance with a preferred demographic, a geographic location, or other suitable selection criteria. In one embodiment, a preferred quantity of current or potential clients in each subset is sufficient to provide a statistically significant sample size to permit evaluation.

The monitoring schemes 380 collect metrics (Ma, Mb, Mc) related to responses and actions of the target clients ({Ea}, {Eb}, {Ec}) in response to the pilot blasts (PBa, PBb, PBc) 370. Metrics related to the responses and actions of the target clients may include an indication as to whether an email has been opened, an elapsed amount of time a screen has been viewed by a target client, an indication as to whether one of the available responses or actions has been undertaken, or another suitable response metric.

The candidate messages (CMa, CMb, CMc) 360 are comparatively evaluated employing the corresponding metrics (Ma, Mb, Mc), preferably employing statistical analysis techniques. One of the candidate messages (CMa, CMb, CMc) is selected as a preferred message 390 based upon the analysis of the evaluation metrics (Ma, Mb, Mc) and associated decision criteria. The decision criteria for the evaluation metrics (Ma, Mb, Mc) may take any suitable form, and preferably include an objective analysis of the evaluation metrics with due consideration for the objective of the contest. The designer of the candidate message selected as the preferred message 390 is supplied the previously identified contest award, e.g., remuneration.

Process 300 is an exemplary embodiment of a method to develop a preferred candidate message by comparing results in small distributions or message blasts, wherein a lead candidate can be sent out in a main message blast. A number of permutations can be executed for the exemplary method. for example, a number of preferred messages can be selected, for example, including the top three messages based upon analysis of an earlier stage of the method. Alternatively, a number of stages can be operated, for example, including a first stage with one hundred candidate messages sent to five hundred email addresses each, a second stage with a top twenty candidate messages selected from the first stage sent to three thousand email addresses each, and a third stage with four preferred messages, each of the preferred messages sent to three hundred thousand email addresses, with each of the preferred messages sent to demographics most responsive in each of the first two stages according to age, gender, geographic region, or other criteria. Such targeted distributions to different demographics for each of a plurality of preferred messages can be based upon analysis of message blasts of candidate messages.

The flowchart and block diagrams in the flow diagrams illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The above description of illustrated examples of the present disclosure, including what is described in the Abstract, are not intended to be exhaustive or to be limitation to the precise forms disclosed. While specific embodiments of, and examples for, the disclosure are described herein for illustrative purposes, various equivalent modifications are possible without departing from the broader spirit and scope of the present disclosure. Indeed, it is appreciated that the specific example voltages, currents, frequencies, power range values, times, etc., are provided for explanation purposes and that other values may also be employed in other embodiments and examples in accordance with the teachings of the present disclosure.

What is claimed is:

1. A computer-implemented method comprising:
in a computerized server:
from each of a plurality of designers, receiving a candidate message;
sending the candidate message to a plurality of target recipients;
monitoring actions of the target recipients in response to the candidate message;
and
compiling metrics associated with the actions of the target recipients;
comparing the metrics for the candidate messages; and
selecting one of the candidate messages as a preferred message based upon the comparing.

2. The computer-implemented method of claim 1, further comprising executing a message blast to a list of current or potential clients employing the preferred message.

3. The computer-implemented method of claim 1, wherein receiving a candidate message from each of a plurality of designers comprises receiving an electronic message configured for a personal communications device.

4. The computer-implemented method of claim 1, wherein receiving a candidate message from each of a plurality of designers comprises receiving an electronic message configured as an email message.

5. The computer-implemented method of claim 1, wherein monitoring the actions of the target recipients in response to the candidate message comprises monitoring whether an email has been opened, an elapsed amount of time a screen was viewed, and if an available response has been undertaken.

6. The computer-implemented method of claim 5, wherein monitoring if an available response has been undertaken includes monitoring if a hyperlink has been activated.

7. The computer-implemented method of claim 1, wherein comparing the metrics for the candidate messages comprises objectively analyzing the metrics employing statistical analysis methods.

8. The computer-implemented method of claim 1, further comprising selecting a plurality of the candidate messages as preferred messages based upon the comparing.

9. The computer-implemented method of claim 8, further comprising:
analyzing the metrics for the candidate messages based upon demographic responses; and
distributing the preferred messages based upon the analyzing.

10. A computer-implemented method comprising:
in a computerized server:
for each of a plurality of writer contestants, receiving a candidate advertising email form;
segmenting a customer email list into a plurality of email sub-lists;
for each email sub-list:
selecting one of the candidate advertising email forms;
electronically sending the selected candidate advertising email form to every email address on the email sub-list; and
monitoring a success metric for the selected candidate advertising email form; and
comparing the success metrics for each of the candidate advertising email form; and
upon a computerized display, displaying success results based upon the comparing.

11. A computerized server comprising:
within the computerized server:
receiving a plurality of messages, each message including a candidate advertising form submitted by a designer;
segmenting a customer contact list into a plurality of contact sub-lists;
sending each candidate advertising form to one of the contact sub-lists;
monitoring a success metric for each of the candidate advertising forms;
comparing the success metrics for each of the candidate advertising forms; and
providing an output declaring a preferred message based upon the comparing.

12. The computerized server of claim 11, further comprising providing a reward to the designer corresponding to the preferred message.

13. The computerized server of claim 11, further comprising providing an output declaring a plurality of preferred messages based upon the comparing.

14. The computerized server of claim 13, further comprising sending each of the plurality of preferred messages to a portion of the customer contact list.

15. The computerized server of claim 11, further comprising implementing a marketing team edit to one of the candidate advertising forms.

16. The computerized server of claim 11, further comprising the preferred message to the customer contact list.

17. The computerized server of claim 11, wherein monitoring the success metric comprises monitoring a rate at which customers open an email.

18. The computerized server of claim 11, wherein monitoring the success metric comprises monitoring a rate at which customers click on a button presented in the candidate advertising form.

19. The computerized server of claim 11, wherein monitoring the success metric comprises monitoring a rate at which customers complete a purchase after having utilized the candidate advertising form.
